(19) United States
(12) Patent Application Publication
(10) Pub. No.: US 2014/0001170 A1
(43) Pub. Date: Jan. 2, 2014

(54) HEATABLE MARBLE COMPOSITE SLAB AND METHOD FOR CONNECTING THE SAME

(71) Applicant: Skala Stone, Inc., Boca Raton, FL (US)

(72) Inventors: Yu-Sung SON, Gwangiu (KR); Jung-Kyu PARK, Seoul (KR)

(73) Assignee: Skala Stone, Inc., Boca Raton, FL (US)

(21) Appl. No.: 14/016,367

(22) Filed: Sep. 3, 2013

Related U.S. Application Data
(63) Continuation-in-part of application No. 13/578,467.

(30) Foreign Application Priority Data
Apr. 11, 2011 (CN) 2011204369163
Dec. 13, 2012 (KR) 10-2012-0145582

(51) Int. Cl. H05B 3/02; B32B 37/18

(52) U.S. Cl. CPC H05B 3/02; B32B 37/18
USPC 219/209; 156/306.6

(57) ABSTRACT

A system and method for a heatable floor or wall covering having a decorative visible surface layer, for example marble or other natural stone. The heatable wall or floor covering includes at least one surface treatment panel, the at least one panel having at least a bottom layer, a heat module layer, and a surface material layer. The heat module layer includes at least one electrically conductive pathway, and the bottom layer includes at least one tab and at least one receiver, each tab and receiver located on a lateral surface of the bottom layer and including an electrical connector in contact with an electrically conductive pathway. When installed, a tab of one panel is matably engageable with a receiver of an adjacent panel, providing at least one continuous electrically conductive pathway between adjacent panels that generates heat, the heat being radiated from the visible surface layer.

### CROSS-REFERENCE TO RELATED APPLICATION

This application is a continuation-in-part-of, and claims priority to, patent application Ser. No. 13/578,467, filed Aug. 10, 2012, entitled “NEW MODEL OF WARM STONE FLOOR MATERIAL,” which is a Submission Under 35 U.S.C. §371 U.S. National Stage Patent of, and claims priority to, PCT/KR2012/003151, filed Apr. 24, 2012, entitled “NEW MODEL OF WARM STONE FLOOR MATERIAL,” which claims priority to Chinese Patent Application Serial No. CN 2011204369163, filed Apr. 11, 2011, entitled “NOVEL GEOTHERMAL FLOOR.” This application also claims priority to Korean Application Serial No. 10-2012-0145582, filed Dec. 13, 2012, entitled “HEATABLE MARBLE COMPOSITE SLAB AND METHOD FOR CONNECTING THE SAME.” The entirety of all of these applications is incorporated herein by reference.

### STATEMENT REGARDING FEDERALLY SPONSORED RESEARCH OR DEVELOPMENT

n/a

### FIELD OF THE INVENTION

The present invention relates to a method and system for providing a heatable marble panel and heatable marble floor.

### BACKGROUND OF THE INVENTION

Natural stone flooring is a product for which there is a high demand because of its beauty and resistance to wear. However, natural stone flooring is expensive to install due to both the cost of the stone and the need for highly skilled labor for installation. Existing stone flooring materials for interior use have a weakness in that most of them are heavy. Generally, in order to make stone flooring material durable, it must be reasonably thick to resist cracking. However, as thickness increases, so does weight and expense. Traditionally, stone is difficult to install and requires concrete, mortar, or mastics when attaching it to floors or walls. Such methods, particularly when installed on vertical surfaces, is not only inconvenient during construction, but often lacks strength.

As an alternative to the expensive, heavy, and difficult-to-handle natural marble, artificial marble has been developed and used to facilitate the installation process and replicate the look and feel of natural marble. However, these artificial marbles are composites consisting of residual natural marble particulates, inorganic filler, and thermosetting plastics, shaped and polished to replicate the feel of natural marble. To manifest the feel of natural marble, relatively large natural marble particulates are used. As a result, the composite material's fluidity declines, leading to fissures, shattering, and bending of finished product.

Some methods have been developed to address these shortcomings of marble panels. For example, some methods involve binding stiffening/reinforcing and shock-absorbing panels to marble panels and incorporating a connecting/locking mechanism.

Use of these kinds of marble panels as wall or floor finishing material in residential environments in apartment and public building complexes or office spaces presents difficulties in readily controlling the temperature when the temperature of the floor is raised, because of marble slate's high thermal capacity. In the case of an apartment expansion project involving a boiler-based heating system, the expanded floor area will have a relatively lower temperature than the area with heating hose installed, causing moisture condensation.

Consequently, there has recently been market demand for marble panels with heating functionality as wall and floor finishing material. Currently known products, however, do not include this feature. For example, some products are an artificial marble with electrically generated radiating heat. This may be achieved by injecting composite ions to a composite polymer with a laser-plasma pulse shock wave acceleration ion injector. However, injection of composite ion using a laser-plasma pulse shock wave acceleration ion injector expends considerable effort and cost and suffers from insufficient heating capability.

As a result, a market demand exists for development of a marble panel with both heating capability and ease of installation, effective in offering a solution to the aforementioned challenges and problems.

### SUMMARY OF THE INVENTION

The present invention advantageously provides a system and method for a heatable floor or wall covering having a decorative visible surface layer, such as a surface layer that is composed of marble or other natural stone product. In one embodiment, the heatable wall or floor covering may include a surface treatment panel that has a first layer having a first length and a first width, a second layer having a second length and a second width, the second layer further having at least one electrically conductive pathway, and a third layer defining a third length and a third width, the third layer further having at least one tab element protruding from at least one of the second length and the second width, and the third layer further having at least one receiver element within at least one of the second length and the second width, each tab element and each receiver element including an electrical connector that is in contact with an electrically conductive pathway. The first layer may be a surface material layer composed of, for example, at least one of marble, granite, onyx, and travertine. The second layer may be a heat module layer and the third layer may be a bottom layer, the panel further including a reinforcement layer having a fourth length and a fourth width, the reinforcement layer being substantially in contact with at least one of the surface material layer and the heat module layer. The second layer may include a heating element, for example, a thermally conductive and electrically resistive material that is in contact with the at least one electrically conductive pathway. This thermally conductive and electrically resistive material may be at least one of a mesh and a fabric, such as a mesh or fabric that is interwoven with at least one carbon fiber. Additionally or alternatively, the heating element may be a thermally conductive and electrically resistive material coating at least a portion of the second layer.

In accordance with another embodiment, a heatable decorative surface system may include a plurality of surface treatment panels, with each surface treatment panel including a surface material layer defining a first surface and a second surface, a heat module layer defining a first surface and a second surface, the first surface of the heat module layer being in contact with the second surface of the surface material layer, the heat module having at least one electrically conductive pathway therein, and a bottom layer defining a first surface and a second surface, the first surface of the bottom layer being in contact with the second surface of the heat module layer, the bottom layer further defining at least one tab along at least one side and at least one groove, each tab and each groove having an electrical connector that is in electrical communication with the at least one electrically conductive pathway. The system may also include a power source configured to provide electrical power to the at least one electrically conductive pathway. For example, the power source may generate an electric current that flows through the at least one electrically conductive pathway of each of the plurality of surface treatment panels. The at least one tab of one of the plurality of surface treatment panels may be matably connected with the at least one groove of at least one other of the plurality of surface treatment panels that is adjacent to the first surface treatment panel. Further, the electrical connector of each of the at least one tab of one of the plurality of surface treatment panels may be in contact with the electrical connector of each of the at least one groove of at least one other of the plurality of surface treatment panels. Each surface treatment panel may include a first pair of tabs, a second pair of tabs, a first pair of grooves, and a second pair of grooves. Further, the first pair of tabs and the second pair of tabs may be coplanar to and positioned on laterally opposing sides of the first pair of grooves and the second pair of grooves. Additionally, a first pair of grooves of a first surface treatment panel may be matably connected with a second pair of grooves of a second surface treatment panel, the second pair of tabs of the first surface treatment panel may be matably connected with a first pair of grooves within a third treatment panel, the first pair of grooves of the first treatment panel may be matably connected with a second pair of tabs of a fourth surface treatment panel, and the second pair of grooves of the first treatment panel may be matably connected with a first pair of tabs of a fifth surface treatment panel. Each surface treatment panel may further define at least one mounting slot on the second surface of the bottom layer, and the at least one mounting slot may be matably engageable with at least one engagement element of a mounting bracket.

In accordance with still another aspect, a method of manufacturing a heatable floor may include bonding a heat module layer to a bottom layer, the heat module layer having a first surface and a second surface that are substantially parallel to each other, the bottom layer having a first surface and a second surface that are substantially parallel to each other, the first surface of the bottom layer being bonded to the second surface of the heat module layer, the heat module layer further having at least one electrical conduction pathway therein, bonding a reinforcement layer to the heat module layer, the reinforcement layer having a first surface and a second surface that are substantially parallel to each other, the first surface of the heat module layer being bonded to the second surface of the reinforcement layer, and bonding a surface layer to the reinforcement layer, the surface layer having a first surface and a second surface that are substantially parallel to each other, the first surface of the reinforcement layer being bonded to the second surface of the surface layer.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a cross-sectional, exploded view of a first embodiment of a heatable marble panel;

FIG. 2 shows a cross-sectional, exploded view of a second embodiment of a heatable marble panel;

FIG. 3 shows a close-up view of a tab member;

FIG. 4 shows a close-up view of a receiving member;

FIG. 5 shows a perspective view of a bottom panel having a first embodiment of connecting members of a heatable marble panel;

FIG. 6 shows a perspective view of a bottom panel having a second embodiment of connecting members of a heatable marble panel;

FIG. 7 shows a top view of a first embodiment of the coupling of a bottom panel and a film-type heating module;

FIG. 8 shows a top view of a second embodiment of a film-type heating module with electrical conductors;

FIG. 9 shows a top view of a third embodiment of a film-type heating module with electrical conductors;

FIG. 10 shows a schematic top view of a portion of a heatable floor created with heatable marble panels;

FIG. 11 shows a bottom view of a heatable marble panel having mounting slots and mounting brackets coupled thereto;

FIG. 12 shows a top plan of a mounting bracket; and

FIG. 13 shows a side view of a mounting bracket.

### DETAILED DESCRIPTION OF THE INVENTION

The present invention provides a heatable marble panel (also referred to as an “architectural plate” or “surface treatment panel”) that is easy to install. Heating capabilities may be provided by incorporating a film/sheet type heating module and connecting elements that connect to and allow electrical current flow to the film/sheet type heating module, as well as a method of connecting the same. The heatable marble panels described herein are arranged to create and radiate heat. Further, the heatable marble panels may be interconnected, providing a secure, heatable flooring without additional tools, special equipment, or special installation expertise. As a wall and/or floor finishing material, these heatable marble panels increase shock absorbency, provide an improved machinability of marble-based panels, and expand applications for which such panels may be used. As used herein, the term “marble,” used for simplicity, refers to any natural stone suitable for use in the heatable panel shown and described herein. For example, the heatable panel may use marble, granite, onyx, travertine, limestone, slate, quartzite, or sandstone.

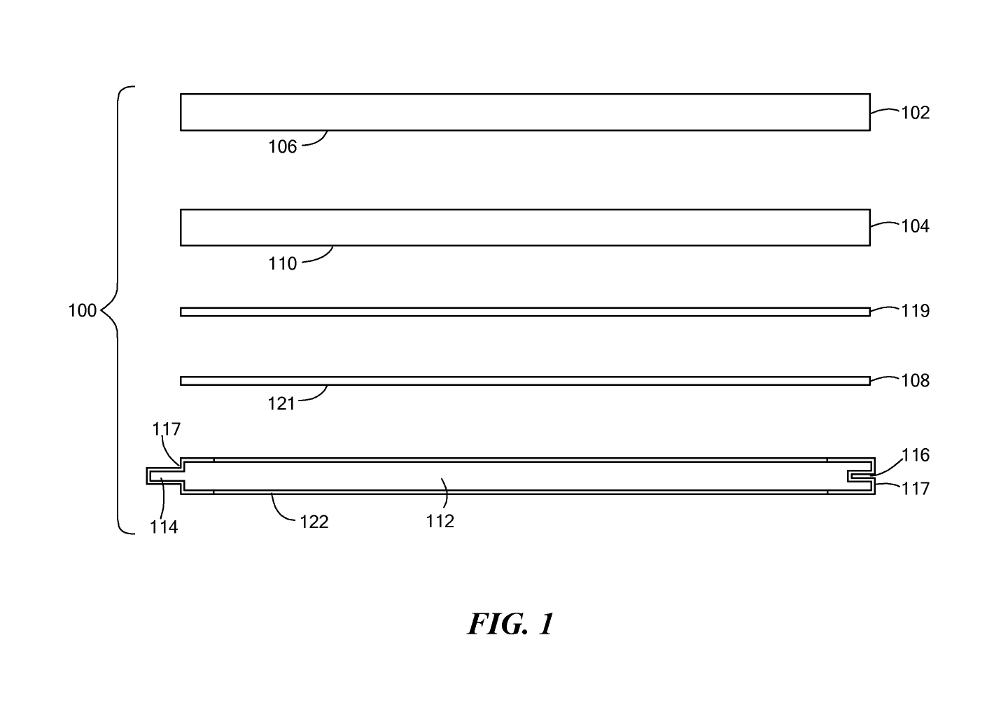

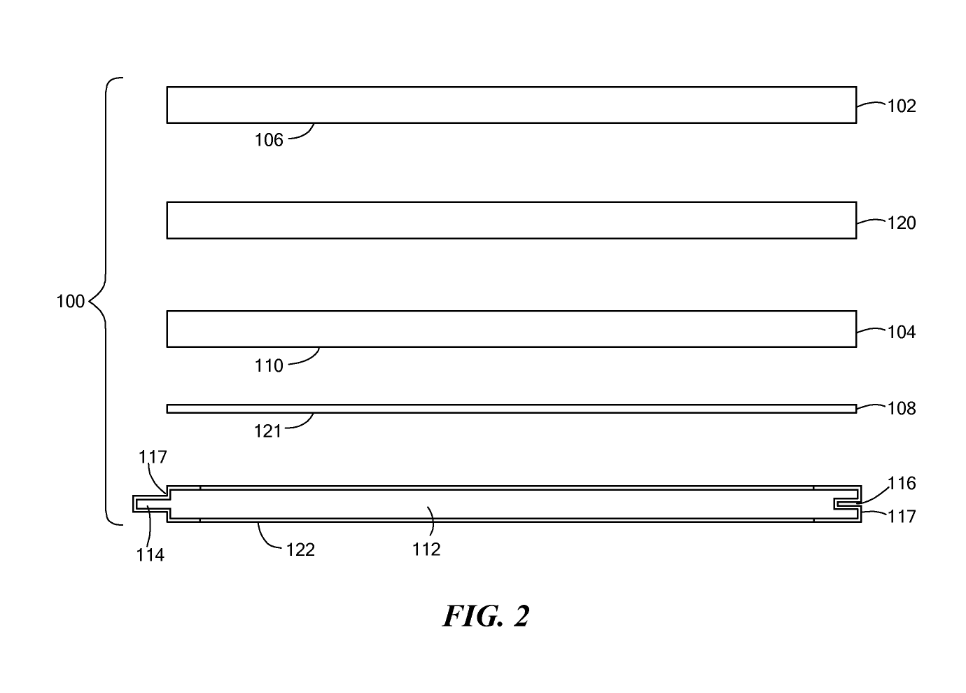

Referring now to FIGS. 1 and 2, a cross-sectional, exploded view of an embodiment of a heatable marble panel is shown. The heatable marble panel 100 may generally include a marble layer 102, a reinforcing/stiffening layer 104 (also referred to herein as a “reinforcement layer 104”) attached to the lower surface 106 of the marble layer 102, a film/sheet-type heating module layer 108 (also referred to herein as a “film-type heating module 108”) attached to the lower surface 110 of the reinforcement layer 104, and a bottom layer 112. The bottom layer 112 may include at least one pair of members having a protruding tab member 114 (simply referred to as “tab 114”) and concave receiving member 116 (simply referred to as “receiver 116”), each tab 114 and receiver 116 pair being coplanar and oriented laterally on opposing side surfaces 117 of the bottom layer 112. Each tab 114 and each receiver 116 may further include a connecting element 118 that is in electrical communication with the heating module 108, allowing electric current flow from a current source to the heating module 108. It will be understood that the layers shown in FIG. 1, and images shown in the other figures as well, are not drawn to scale.

Although not shown in the figures, the heatable marble panel 100 may have a different configuration of layers. As a non-limiting alternative example, instead of being located directly beneath the reinforcement layer 104, the heating module 108 may be located directly beneath the marble layer 102 and directly above the reinforcement layer 104. Alternatively, the heating module 108 may be located directly beneath the marble layer 102 and directly above the bottom layer 112, in which case the marble panel 100 may not include a reinforcement layer 104.

The marble layer 102 may be composed of natural or artificial marble, and may have a shape that is, for example, rectangular, square, polygonal, or other geometric shape having a length and a width, and having a thickness of between approximately 2 mm and approximately 5 mm. As a non-limiting example, the marble layer 102 may be a veneer of flooring surface having a rectangular shape and being approximately 2.5 mm thick. Although this top layer 102 is referred to as a “marble layer 102,” the layer may alternatively be composed of natural or artificial stone, cork, coral, wood, concrete, or other finishing or facing materials. Further, the invention is not limited to the features described herein, and any shape, size, and/or material may be used for, at least, the marble layer 102.

On the lower surface 106 of the marble layer 102, a reinforcement layer 104 of equal size to the marble layer 102 may be attached, for example, with a bonding agent. The reinforcement layer 104 may supplement the strength of the marble layer 102 to prevent fracturing and/or shattering of the marble layer 102, and may cover substantially the entire lower surface 106 of the marble layer 102 or be attached intermittently within or on grooves and/or irregular surfaces of the lower surface 106 of the marble layer 102 (not shown) to give a grooved or irregular lower surface 106 a smooth, horizontal surface. The bonding agent used to attach the reinforcement layer 104 and/or other layers may be selected at the discretion of the manufacturer, from wide variety of publicly known bonding agents. The reinforcement layer 104 may be composed of, but is not limited to, cellulose fiber reinforced cement (CRC) board, ECOBOARD™ (a multidirectional fiber board made from agricultural byproducts instead of wood), fiberglass reinforced board, urethane foam board, or aluminum composite board. Further, the reinforcement layer 104 may be composed of any material and have any configuration that may serve to improve the ability of the marble layer 102 to withstand physical impact. As a non-limiting example, the reinforcement layer 104 may be composed of a mesh material 119 having a thickness of approximately 0.3 mm. In addition or as an alternative to the reinforcement layer 104, a shock absorption layer 120 or areas of shock absorption material (as shown in FIG. 2) may be attached to lower surface 106 of the marble layer 102 to further reinforce the marble layer 102.

A film-type heating module 108 may be attached to the lower surface 110 of the reinforcement layer 104. The heating module 108 may include a thin, flat sheet or film, which may itself be composed of thermally conductive and electrically resistive material, or a thermally conductive and electrically resistive material may be incorporated into or otherwise combined with, coupled to, or layered with the film (and collectively referred to as the heating module 108) as a heating element. Further, the resistive heat caused by passing electric current through electrically resistive material of the heating module 108 may be transferred to the marble layer 102 by conduction, thus providing a heated marble panel 100.

The heating module 108 may include a heating fabric that is composed of calescent fiber weaved into a mesh 119 (for example, as shown in FIG. 1). In one embodiment, the calescent fiber may incorporate carbon, but in other embodiments may not include carbon. It will be understood that the heating module 108 may be composed of any of a variety of electrically resistive materials, but should have a film- or sheet-type structure. For example, the film-type heating module 108 may be formed by weaving non-carbon fibers, warp and weft, in a plain weaving pattern, and weaving into a mesh a number of calescent fibers in between the wefts in an interval. In the case of a heating fabric that includes calescent carbon fiber, interweaving with non-carbon fiber may increase the tensile strength and adds to the overall shock absorption capability. Also, heating the calescent carbon fiber produces far infrared rays (FIR), a form of radiation energy with advantageous effects on human body. For example, FIR are known to stimulate cellular metabolism which increases the body's regenerative ability and helps restore the proper function of the nervous system.

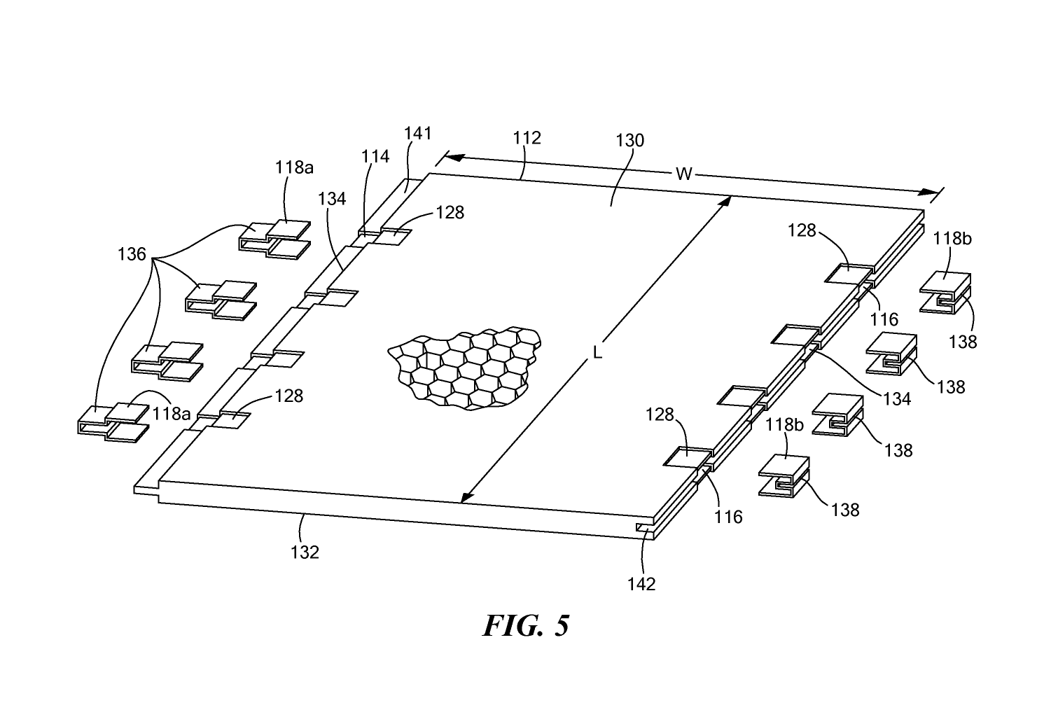

The bottom layer 112 may attach to the lower surface 121 of the film-type heating module 108. The bottom layer 112 may form the last layer of the heatable marble panel 100 (that is, bottommost layer when the heated marble panel 100 is installed on a floor, for example). When installing the heatable marble panel 100 as a wall of floor finishing material, the lower surface 122 of the bottom layer 112 comes in contact with the wall or floor. As a non-limiting example, the bottom layer 112 may be composed of, but is not limited to, polymeric material such as polyethelene (PE), polypropylene (PP), and melamine resin. Further, the bottom layer 112 may define a plurality of air pockets, voids, or air traps 123 (for example, in a honeycomb-like structure) of any of a variety of shapes, such as rectangles, hexagons, or rhombi, dispersed on the lower surface 122 of the bottom layer 112 (as shown in the partial cutaway of the bottom layer 112 of FIG. 5).

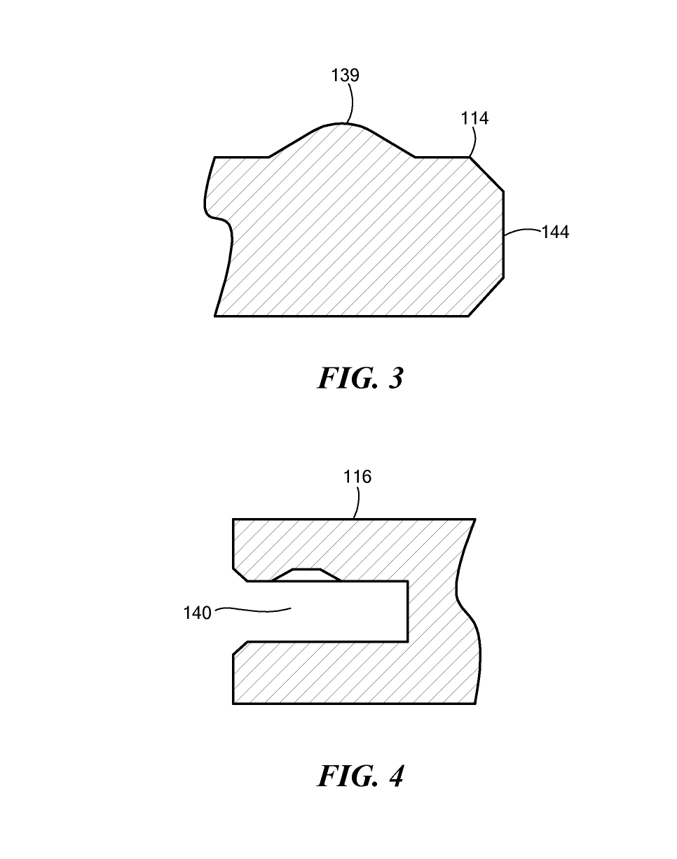

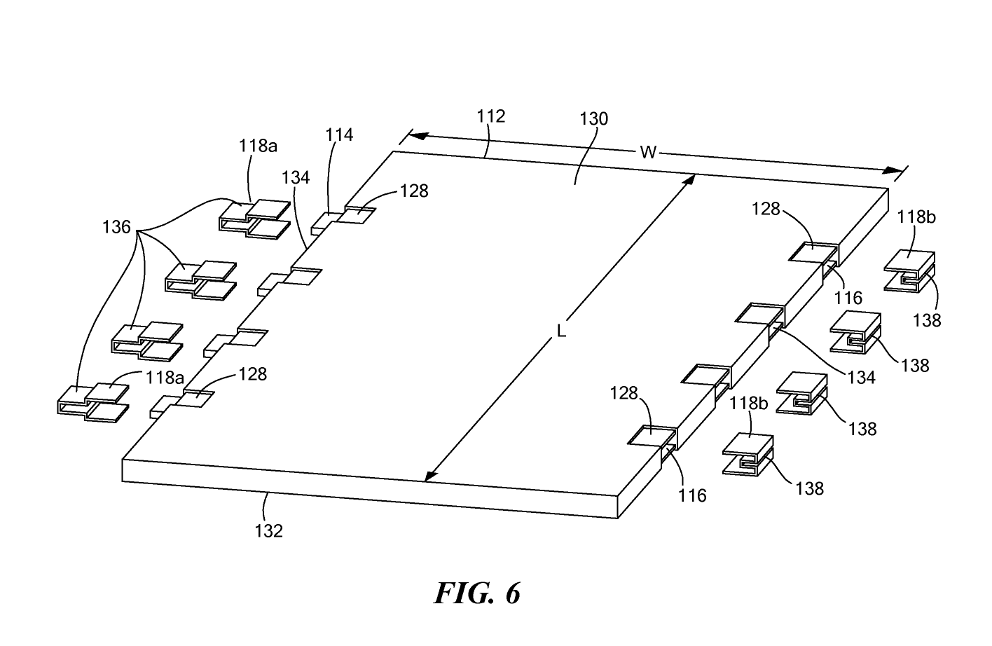

The bottom layer 112 may have a shape with a length (“L”) and width (“W”) corresponding to the length and width of the marble layer 102, reinforcement layer 104, and film-type heating module 108. However, as shown in FIGS. 3 and 4, the bottom layer 112 may include a series of tabs 114 or receivers 116 positioned such that at least one pair of a coplanar tab 114 and receiver 116 are oriented laterally on opposing side surfaces 117 of the bottom layer 112. When installing and interconnecting multiple marble panels 100, the mating of a tab 114 with a corresponding receiver 116 (inserting the tab 114 into the receiver 116) facilitates a firm and seamless connection. When the marble panel 100 includes a plurality of tab 114 and a plurality of receivers 116, each of the plurality of tabs 114 and plurality of receivers 116 may have a continuous (mono-body, as shown in FIG. 5) or discontinuous (corrugation-like, as shown in FIG. 6) configuration disposed along the entire length of opposing side surfaces 117 of the bottom panel 112. Further, each pair of a tab 114 and a receiver 116 may feature a click-and-lock engagement mechanisms designed to further prevent separation from each other, without the need for adhesives. The tabs 114 and receivers 116 are generally about equal in size to each other and provide a tight fit. It will be understood that, although not shown, tabs 114 and receivers 116 may be located on the same side surface 117 of the bottom layer 112 and designed to coordinate with corresponding tabs 114 and receivers 116 on adjacent marble panels 100.

Each tab 114 and receiver 116 may include an electrically conductive connecting element 118. The connecting elements 118 may be composed of an electrically conductive material (for example, a metal) that permits flow of electrical current to the heating module 108. In installing and connecting marble panels 100, the connecting elements 118 may come into contact with electrical terminals 124 of electrical conductors 126 within adjacent marble panels 100 and thereby establish an electrical connection amongst physically connected marble panels 100. The electrically conductive connecting elements 118 may be elastic and be sized and shaped to attach (for example, to clip) onto the tabs 114 and receivers 116. The bottom layer 112 may further include a plurality of indented areas or grooves 128, each indented area 128 corresponding to, and matching the size and shape of, a connecting element 118, allowing connecting elements 118 of adjacent marble panels 110 to come in contact with each other and establish an electrical connection amongst physically connected marble panels 100. The indented areas 128 may be disposed along one or more areas on the top 130 and/or bottom 132 surface of the bottom layer 112, proximate an edge 134. Additionally or alternatively, the one or more indented areas 128 may be disposed on the one or more tabs 114 and receivers 116. Alternatively, in the process of forming the bottom layer 112, the connecting elements 118 may be integrated with the bottom layer 112, such as through double injection molding.

In installing and interconnecting the marble panels 100 by inserting the one or more tabs 114 of one panel 100 into the one or more receivers 116 of another panel 100, the connecting members 118 attached to the tabs 114 and receivers 116 may come in contact with each other and establish a simple, yet uninterrupted, electrical connection amongst physically connected marble panels 100. The interconnection between adjacent marble panels 100 may be further strengthened by including corrugation-like structures on the distalmost end 136 of the connecting elements 118a that are attached to the tabs 114. Likewise, corrugation-like structures may also be disposed within at least a portion of the concavity 138 of the connection elements 118b that are attached to the receivers 116. These structures may be small, and in some embodiments may be microscopic. It will be understood, however, that the structure of the socket-and-plug-type system is not limited to microscopic corrugation design.

Referring now to FIGS. 3 and 4, a close-up view of each of a tab and receiver is shown. As described, the tabs 114 of one heatable marble panel 100 may be interconnectable with (that is, matably engageable with) the receivers 116 of another heatable marble panel 100. As a non-limiting example, this may be accomplished by including a bump or raised area 139 on a distal portion of the tab 144 (as shown in FIG. 3) that corresponds to a concave area or socket 140 within a surface of the receiver (as shown in FIG. 4). Thus, a tab 114 and receiver 116 may be matably engageable using a click-to-lock system as shown in FIGS. 3 and 4.

Referring now to FIGS. 5 and 6, a perspective view of a first and second bottom panel and connecting members of a heatable marble panel is shown. FIG. 5 shows a first embodiment in which tabs 114 and receivers 116 are disposed in a monobody configuration. That is, the tabs 114 are disposed on a single flare or strip 141 that protrudes from the side surface of and may run the length L of the bottom layer 112. Also, the receivers 116 on the opposing side surface of the bottom layer 112 share a common concavity or groove 142 that may run the length L of the bottom layer 112. FIG. 6 shows a second embodiment having discontinuous, corrugated-type configuration in which tabs 114 and receivers 116 are independent of each other (that is, do not share a common strip 141 and/or groove 142). Each connecting element 118a associated with a tab 114 may be configured to be disposed about the tab 114 (as shown in FIGS. 3 and 4). Likewise, each connecting element 118b associated with a receiver 116 may be configured such that at least a portion of the connecting element 118b is disposed within (that is, follows the shape of) the receiver 116 (as shown in FIGS. 3 and 4). This feature of the connecting elements 118 may facilitate mating or coupling of tabs 114 and receivers 116 of adjacent marble panels 100.

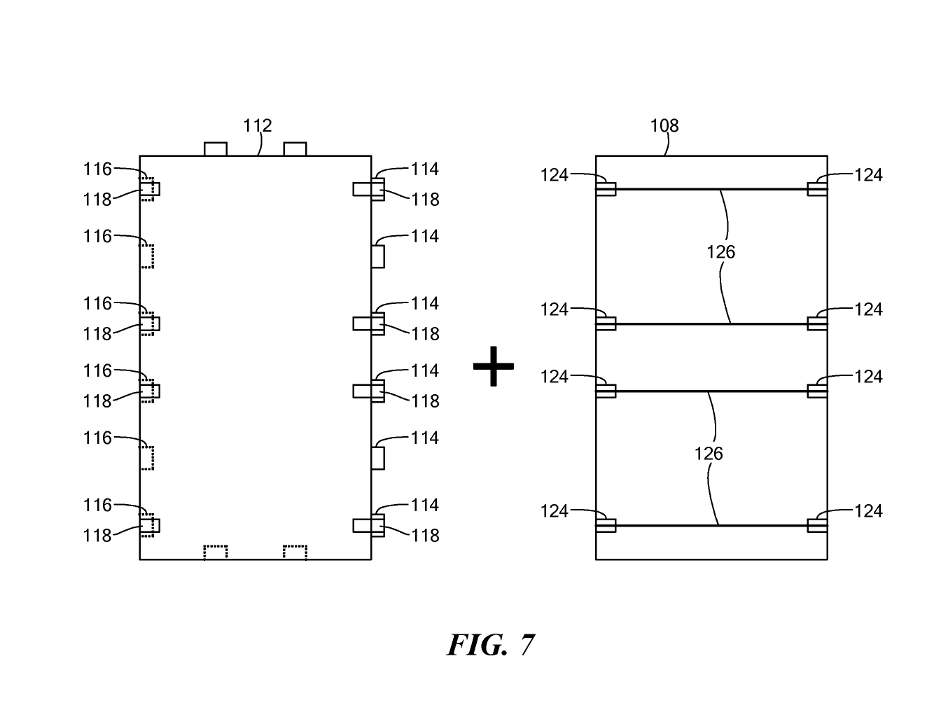

Referring now to FIGS. 5-3C, a top view of a first and second embodiment of the coupling of a bottom panel and a film-type heating module is shown. As shown in FIGS. 5-6, the number and location of the connecting elements 118 corresponds to the number and location of the electrical conductors 126 within the same marble panel 100 as well as those of the connecting elements 118 of interconnected marble panels 100. As is shown, for example, in FIG. 7, connecting elements 118 may not be attached to tabs 114 or receivers 116 (and associated indented areas 128, if included) that do not correspond to electrical conductors 126.

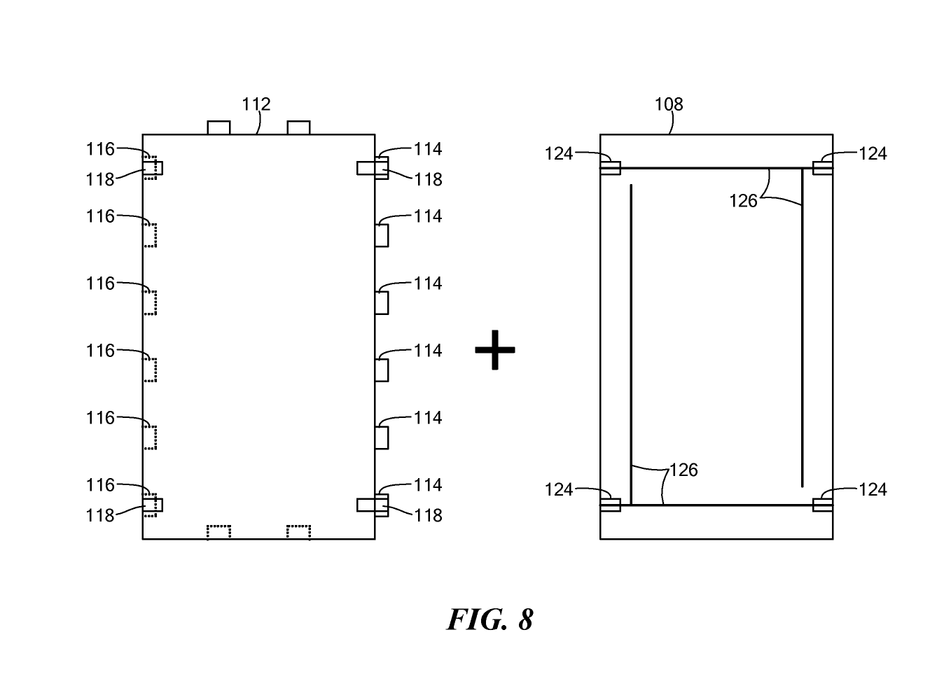

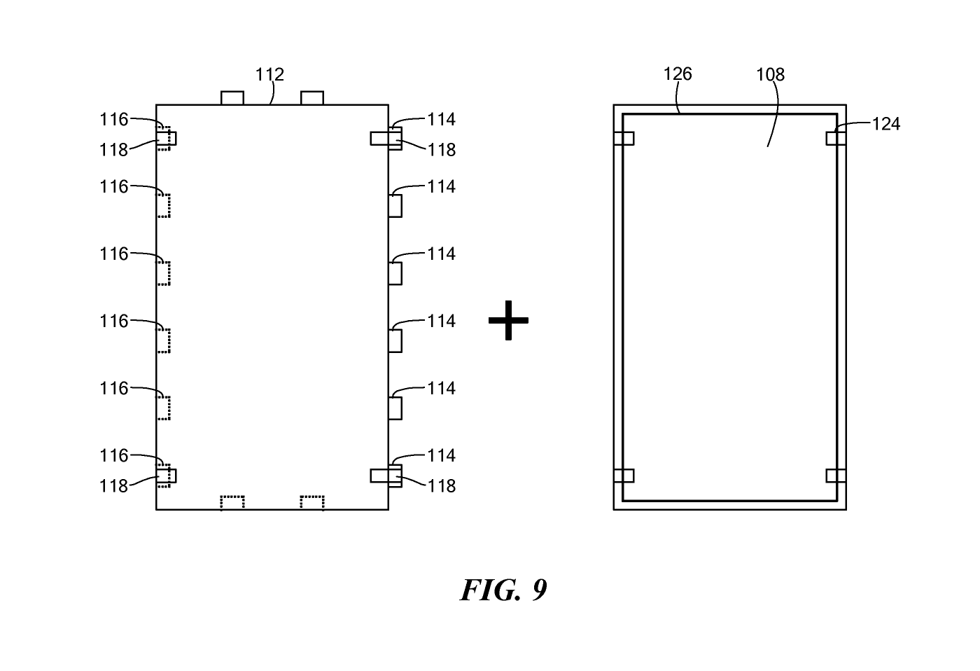

Each electrical conductor 126, which may be included in the heating module 108 layer, may be electrically connected to one or more connecting elements 118 of an adjacent bottom 112 layer via one or more electrical terminals 124. For example, the connecting elements 118 attached to the tabs 114 and receivers 116 in FIGS. 3 and 4 may come into contact with the electrical terminals 124 of the electrical conductors 126 that are attached to the film-type heating module 108, thereby establishing an electrical current path between adjacent heatable marble panels 100 and between an electricity source and the heating module 108. The number and location of the electrical terminals 124 may correspond to the number and location of the connecting elements 118. The electrical conductors may act as conduits through which electrical current originating from the connecting elements 118 flows to and within the heating module 108. To provide an ample eclectic power supply, at least one pair of electrical conductors 126 of opposite polarity may be included in the heating module 108. Further, some electrical conductors 126 may traverse the heating module 108 between two opposing edges (as shown in FIGS. 5 and 6) and/or may form a band that at least partially covers the edges of the heating module 108 (as shown in FIG. 9). As shown in FIG. 8, it is possible to deliver electrical power supply through two electrical conductors 126 that serve as positive (+) and negative (−) terminals located on opposing sides (in such case, electrical conductors of different polarity are arranged in alternating fashion). However, it will be understood that arrangement of the electrical conductors is not limited to the embodiments shown and described herein.

As discussed, the electrical conductors 126 may establish an electrical connection with connecting elements 118, the number and location of electrical conductors 126 may match the number and location of the connecting elements within the same marble panel 100. To further enhance the electrical conductivity between a connecting element 118 and electrical conductor 126, a electrically conductive material can be introduced between the opposing contact surfaces of a connecting element 118 and electrical conductor 126. The electrically conductive material may include an electrically conductive bonding agent (for example, lead solder or the like). In coupling the bottom layer 112 and the heating element 108, an electrically conductive bonding agent may be introduced between the opposing contact surfaces of a connecting element 118 and electrical conductor 126. Similarly, opposing contact surfaces of connecting elements 118 and electrical conductors 126 may include one or more holes or indentations (for example, the plurality of air pockets 123 in the bottom layer 112) into which lead solder may be applied.

In a non-limiting example, the marble panel 100 may include at least two electrical conductors 126 of opposite polarity attached to the heating module 108. As electrical power is supplied to the electrical terminals 124 of the electrical conductors 126 of opposing polarity, the pair of electrical conductors 126 may create a voltage gradient across the heating module 108. As a result, current may flow between the electrical conductors 126 and through the heating module 108, thereby generating resistive heat. In particular, electrical power may be supplied through the electrical conductors 126, which have a relatively higher electrical conductivity. As electric current flows through the heating module 108, which has a relative lower electrical conductivity, resistive heat may be generated. To that end, the electrical conductors 126, with a relatively higher electrical conductivity, may be integrated onto the heating module 108 utilizing a multilayer process such as screen printing. If a calescent fabric is used as the heating module 108, the fabric may be interwoven with one or more materials having a high electrical conductivity, such as copper, brass, and/or aluminum. For example, these conductive materials may be interwoven with the fiber at the location at which the connecting elements 118 come in contact with the fabric, forming simplistic electrical conductors 126.

The electrical conductors 126 may be incorporated or attached to the heating module 108 using any of a variety of methods. For example, the electrical conductors 126 may be composed of a combination of nickel, bronze, and plastic, and the heating module 108 film may be composed of a combination of carbon and plastic. Both the materials of the heating conductors 126 and the materials of the film may be, for example, in powder form and combined with an adhesive and amalgamated into a liquefied form. Then, each may be applied (for example, sprayed on as a coating) to a separate second film to collectively compose the heating module 108. Alternatively, the film material and electrical conductor 126 material may be molded together, the hardened final product being electrically and/or thermally conductive. Alternatively, the powdered electrical conductor 126 material may be combined with an adhesive and amalgamated into a liquefied form, and then sprayed directly onto the film, without using the separate second film. In both of these embodiments, the electrical conductors 126 may be sprayed, molded, or printed onto the heating module 108 film. Alternatively, the first film may be molded with a second film, at least one of which being electrically and/or thermally conductive. Alternatively, wires may be integrated with (for example, adhered to or molded into) the heating module 108 film. The wires may themselves be electrically and/or thermally conductive, or they may be coated with an electrically and/or thermally conductive paint or layer.

In addition to the electrical conductors 126, other calescent or heating elements may be integrated or associated with the heating module 108. For example, one or more heating coils may be used as heating elements. Additionally or alternatively, calescent material such as carbon fiber (for example, woven into a fabric or mesh, with or without integrated electrical conductors 126) or carbon thread may be used as heating elements. Further, it will be understood that any of these elements may also be used in combination, and heating methods are not limited to those described herein.

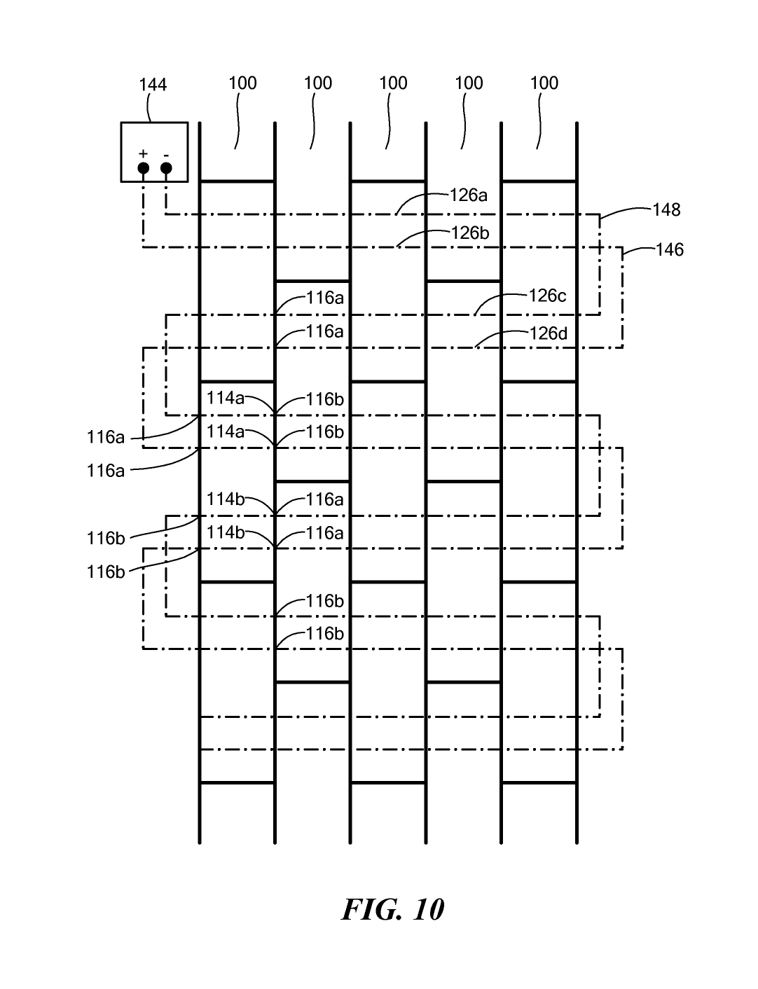

Referring now to FIG. 10, a schematic top view of a portion of a heatable floor created with heatable marble panels is shown. When adjacent heatable marble panels 100 are properly installed and interconnected, the floor is strong, remains in place, and is resistant to the effects of heat expansion and/or heat contraction. In the floor portion shown in FIG. 10, each marble panel 100 may incorporate two pairs of electrical conductors 126, with each pair being disposed on opposing ends of the marble panel 100. Tabs 114 and receivers 116 may be integrated onto the bottom layer 112 of each heatable marble panel 100, and may be coupled with the tabs 114 and receivers 116 of adjacent heatable marble panels 100.

In the non-limiting example shown in FIG. 10, each marble panel 100 may include a first pair of tabs 114a, a second pair of tabs 114b, a first pair if receivers 116a, and a second pair of receivers 116b (shown in the simplified view of FIG. 10). The first pair of tabs 114a and the first pair of receivers 116a may each be coupled to different but adjacent first second pair of receivers 116b and second pair of tabs 114b, respectively. Further, each marble panel 100 may include a first electrical conductor 126a and a second electrical conductor 126b corresponding to the first pair of tabs 114a and receivers 116a, and a third electrical conductor 126c and fourth electrical conductor 126d corresponding to the second pair of tabs 114b and receivers 116b. The first and third electrical conductors 126a, 126c may be supplied with positive voltage to induce current, whereas the second and fourth electrical conductors 126b, 126d may be supplied with negative voltage (or ground) from an external power source 144. For example, the external power source 144 may be a standard household or office electrical plug. Through the interconnection of the electrical conductors 126a-126d, an electrical pathway to facilitate current flow from the positive electrical pathway 146 through the negative electrical pathway 148 throughout the heatable floor may be formed. The electrical power supplied via the electrical pathways 146, 148 may facilitate resistive heat generation within the heating modules 108. Further, it will be understood that the marble panels 100 may be interconnected in any of a variety of sizes and configurations, and is not limited to the configuration shown in FIG. 10.

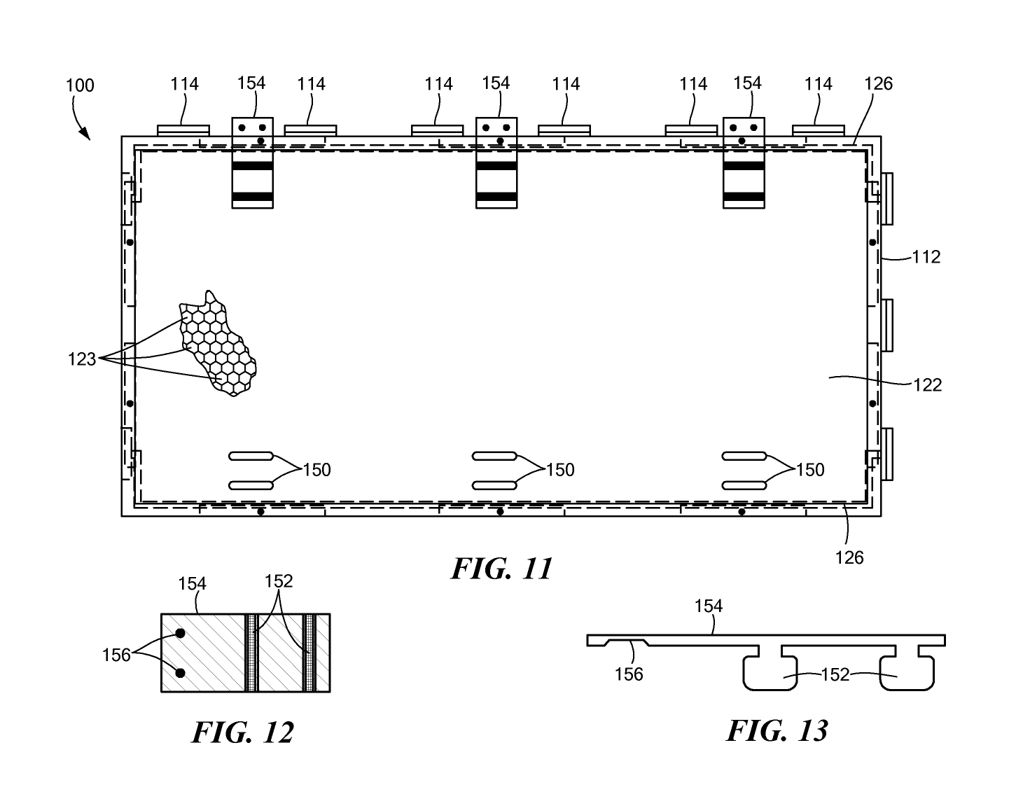

Referring now to FIG. 11, a bottom view of a heatable marble panel having mounting slots and mounting brackets coupled thereto is shown. The lower surface 122 of the bottom layer 112 of a marble panel 100 may include a plurality of mounting slots 150 that may be used to mount the marble panel 100 to a wall (for example, the panel 100 may be screwed, bolted, or pinned to a wall using mounting brackets). In the non-limiting example shown, the lower surface 122 may include six pairs of mounting slots 150, each having dimensions of approximately 5 mm by approximately 32 mm. The slots 150 may be sized to engage with protrusions 152 of the mounting brackets 154 (as shown and described in more detail in FIGS. 12 and 13). For example, each mounting slot 150 may include a lip or flange around at least a portion of the slot 150 opening that is engageable with a protrusion 152 of a mounting bracket 154.

In an exemplary method of mounting a marble panel 100 to a wall, one or more mounting brackets 154 may first be affixed to the wall, such as with bolts, screws, pins, or the like. In the non-limiting embodiment shown in FIG. 11, three mounting brackets 154 may be affixed to the wall, each mounting bracket 154 corresponding to a pair of mounting slots 150 along the same side of the lower surface 122 of the bottom layer 112. It will be understood that more or fewer mounting brackets 154 and/or mounting slots 150 may be used, and that mounting brackets 154 may be engaged with mounting slots 150 on both sides of the lower surface 122 of the bottom layer 112.

Referring now to FIGS. 12 and 13, a top view and side view of a mounting bracket are shown. The mounting bracket 154 may include one or more protrusions 152 and one or more screw holes 156. The number, size, and location of the one or more protrusions 152 may correspond to the number, size, and location of the mounting slots 150 on the lower surface 122 of the bottom layer 112. For example, if the bottom panel 112 includes mounting slots 150 in pairs, the mounting bracket 154 may include two protrusions 152, such that a mounting bracket 154 is engageable with each pair of mounting slots 150. However, mounting brackets 154 may be used that are engageable with one or more than two mounting slots 150. The mounting bracket 154 may be composed of, for example, a strong yet lightweight material such as aluminum or plastic. Alternatively, a first portion of the mounting bracket 154 may be composed of plastic whereas a second portion of the mounting bracket 154 may be composed of metal such as aluminum. In a non-limiting embodiment, the portion of the mounting bracket 154 that includes the one or more screw holes 156 may be composed of plastic, whereas the portion that includes the one or more protrusions 152 may be composed of metal.

As is shown in FIG. 13, each protrusion 152 may have a flanged shape that is engageable in a click-to-lock fashion with a mounting slot 150, such as a mounting slot 150 that includes a lip or flange about at least a portion of the slot 150 opening. Further, each screw hole 156 may be recessed to allow for countersinking of, for example, a screw, bolt, or pin. Although referred to as a “screw hole,” the screw holes 156 may be usable with bots, pins, or other hardware.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A surface treatment panel, the panel comprising:
a first layer having a first length and a first width;
a second layer having a second length and a second width, the second layer further having at least one electrically conductive pathway; and
a third layer defining a third length and a third width, the third layer further having at least one tab element protruding from at least one of the second length and the second width, and the third layer further having at least one receiver element within at least one of the second length and the second width, each tab element and each receiver element including an electrical connector that is in contact with an electrically conductive pathway.

2. The panel of claim 1, wherein the first layer is a surface material layer composed of at least one of marble, granite, onyx, and travertine.

3. The panel of claim 2, wherein the second layer is a heat module layer and the third layer is a bottom layer, the panel further comprising a reinforcement layer having a fourth length and a fourth width, the reinforcement layer being substantially in contact with at least one of the surface material layer and the heat module layer.

4. The panel of claim 1, wherein the second layer further comprises a heating element.

5. The panel of claim 4, wherein the heating element is a thermally conductive and electrically resistive material that is in contact with the at least one electrically conductive pathway.

6. The panel of claim 5, wherein the thermally conductive and electrically resistive material is at least one of a mesh and a fabric.

7. The panel of claim 6, wherein the at least one of a mesh and a fabric is interwoven with at least one carbon fiber.

8. The panel of claim 4, wherein the heating element is a thermally conductive and electrically resistive material coating at least a portion of the second layer.

9. The panel of claim 8, wherein the heating element is composed at least in part of carbon.

10. The panel of claim 1, wherein the third layer defines a plurality of voids therein.

11. A heatable decorative surface system, the system comprising:
a plurality of surface treatment panels, each surface treatment panel including:
a surface material layer defining a first surface and a second surface;
a heat module layer defining a first surface and a second surface, the first surface of the heat module layer being in contact with the second surface of the surface material layer, the heat module having at least one electrically conductive pathway therein; and
a bottom layer defining a first surface and a second surface, the first surface of the bottom layer being in contact with the second surface of the heat module layer, the bottom layer further defining at least one tab along at least one side and at least one groove, each tab and each groove having an electrical connector that is in electrical communication with the at least one electrically conductive pathway; and
a power source configured to provide electrical power to the at least one electrically conductive pathway.

12. The system of claim 11, wherein the power source generates an electric current that flows through the at least one electrically conductive pathway of each of the plurality of surface treatment panels.

13. The system of claim 12, wherein the at least one tab of one of the plurality of surface treatment panels is matably connected with the at least one groove of at least one other of the plurality of surface treatment panels that is adjacent to the first surface treatment panel.

14. The system of claim 13, wherein the electrical connector of each of the at least one tab of one of the plurality of surface treatment panels is in contact with the electrical connector of each of the at least one groove of at least one other of the plurality of surface treatment panels.

15. The system of claim 12, wherein each surface treatment panel includes a first pair of tabs, a second pair of tabs, a first pair of grooves, and a second pair of grooves.

16. The system of claim 15, wherein the first pair of tabs and the second pair of tabs are coplanar to and positioned on laterally opposing sides of the first pair of grooves and the second pair of grooves.

17. The system of claim 16, wherein a first pair of grooves of a first surface treatment panel is matably connected with a second pair of grooves of a second surface treatment panel, the second pair of tabs of the first surface treatment panel is matably connected with a first pair of grooves within a third treatment panel, the first pair of grooves of the first treatment panel is matably connected with a second pair of tabs of a fourth surface treatment panel, and the second pair of grooves of the first treatment panel is matably connected with a first pair of tabs of a fifth surface treatment panel.

18. The system of claim 11 wherein each surface treatment panel further defines at least one mounting slot on the second surface of the bottom layer.

19. The system of claim 18, the system further comprising a plurality of mounting brackets, each of the plurality of mounting brackets defining at least one engagement element that is matably engageable with the at least one mounting slot.

20. A method of manufacturing a heatable floor, the method comprising:
bonding a heat module layer to a bottom layer, the heat module layer having a first surface and a second surface that are substantially parallel to each other, the bottom layer having a first surface and a second surface that are substantially parallel to each other, the first surface of the bottom layer being bonded to the second surface of the heat module layer, the heat module layer further having at least one electrical conduction pathway therein;
bonding a reinforcement layer to the heat module layer, the reinforcement layer having a first surface and a second surface that are substantially parallel to each other, the first surface of the heat module layer being bonded to the second surface of the reinforcement layer; and
bonding a surface layer to the reinforcement layer, the surface layer having a first surface and a second surface that are substantially parallel to each other, the first surface of the reinforcement layer being bonded to the second surface of the surface layer.
